(19) United States
(12) Patent Application Publication
(10) Pub. No.: US 2013/0321795 A1
(43) Pub. Date: Dec. 5, 2013

(54) DEFECT TESTER

(71) Applicant: BELVAC PRODUCTION MACHINERY, INC., Lynchburg, VA (US)

(72) Inventors: Stephen Packer, Goode, VA (US); Ric Keesee, Goodview, VA (US); Michael Supernaw, Lynchburg, VA (US)

(73) Assignee: Belvac Production Machinery, Inc., Lynchburg, VA (US)

(21) Appl. No.: 13/800,655

(22) Filed: Mar. 13, 2013

Related U.S. Application Data
(60) Provisional application No. 61/653,623, filed on May 31, 2012.

(51) Int. Cl. G01N 21/17

(52) U.S. Cl. CPC G01N 21/17
USPC 356/237.1

(57) ABSTRACT

A defect tester for detecting a defect in an article in a machine arrangement includes a starwheel having one or more pockets configured to hold respective one or more articles. The defect tester further includes one or more disks. Each of the one or more disks has one or more openings. Each of the one or more openings includes a covering configured to form a seal with an open end of the article. The defect tester further includes one or more detector units configured to detect a range of radiation wavelengths in an interior of the article. The radiation wavelengths are directed on an exterior of the article. The one or more detector units are further configured to communicate to a controller whether a defect has been detected.

### CROSS-REFERENCE TO RELATED APPLICATIONS

This application claims the benefit of U.S. Provisional Application No. 61/653,623 filed May 31, 2012, which is hereby incorporated by reference in its entirety.

### FIELD OF EMBODIMENTS

The present embodiments relate generally to a defect tester and, more specifically, to a defect tester for detecting one or more unintended openings in an article.

### DESCRIPTION OF RELATED ART

Defect testers may be used, for example, in a machine arrangement, to help detect whether an article (e.g., can, container) includes a defect. A defect may be any unintended opening in the article. For example, if the article is a can that has not yet been closed on the top, the unintended opening to be detected might be located in a side and/or bottom of the can.

The defect tester may include one or more wavelength emitters that direct radiation wavelengths on the article and a detector unit that determines whether radiation wavelength(s) enter the article. When radiation wavelength(s) enter the article through an unintended opening in the article, a defect is determined to be present.

A need exists for an improved defect tester such that unintended openings and defects may be more easily and/or rapidly detected.

### SUMMARY OF THE INVENTION

According to one embodiment, a defect tester for detecting a defect in an article in a machine arrangement includes a starwheel having one or more pockets configured to hold respective one or more articles. The defect tester further includes one or more disks. Each of the one or more disks has one or more openings. Each of the one or more openings includes a covering configured to form a seal with an open end of the article. The defect tester further includes one or more detector units configured to detect a range of radiation wavelengths in an interior of the article. The radiation wavelengths are directed on an exterior of the article. The one or more detector units are further configured to communicate to a controller whether a defect has been detected.

According to one process, a method of detecting one or more defects in one or more articles passing through a machine arrangement includes transferring an article from a component of the machine arrangement to a defect tester starwheel. The method further includes passing the article from the defect tester starwheel to an opening of one or more disks of a defect tester. The opening includes a covering configured to form a seal with an open end of the article. The method further includes directing one or more radiation wavelengths on an exterior of the article. The method further includes detecting, using one or more detector units, the one or more radiation wavelengths in an interior of the article. The method further includes communicating to a controller whether a defect has been detected.

According to another embodiment, a machine arrangement for processing one or more articles includes a plurality of modules arranged to cooperate with one another. At least one of the modules includes a turret arrangement configured to modify one or more articles. The turret arrangement includes at least one turret starwheel and at least one transfer starwheel. Each of the at least one turret starwheel and the at least one transfer starwheel include a plurality of pockets adapted to hold or transfer the one or more articles. The machine arrangement further includes a wavelength emitter arrangement for directing radiation wavelengths on the exterior of one or more articles. The machine arrangement further includes a defect tester including one or more disks. Each of the one or more disks has one or more openings. Each of the one or more openings including a covering configured to form a seal with an open end of the one or more articles. The defect tester further includes one or more detector units configured to detect the radiation wavelengths emitted by the wavelength emitter in an interior of the one or more articles. The machine arrangement further includes at least one controller for controlling at least one of the defect tester and the plurality of modules.

Additional aspects of the invention will be apparent to those of ordinary skill in the art in view of the detailed description of various embodiments, a brief description of which is provided below.

### BRIEF DESCRIPTION OF THE DRAWINGS

Features, aspects and advantages of the disclosed embodiments will become apparent from the following description and the accompanying exemplary embodiments shown in the drawings, which are briefly described below.

FIG. 1 is a side view of a machine arrangement.

FIG. 2 is a top view of a defect tester in a machine arrangement.

FIG. 3 is a side view of a detector unit of the defect tester.

FIG. 4 is a top view of the detector unit of FIG. 3.

FIG. 5 is a side perspective view of a defect tester in a machine arrangement.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention.

### DETAILED DESCRIPTION

Illustrative embodiments are illustrated in the drawings. An effort has been made to use the same or like reference numbers throughout the drawings to refer to the same or like parts.

The disclosure relates to a defect tester. The defect tester may be used in a machine arrangement or any other suitable arrangement. The defect tester detects defects (e.g., unintended openings) in one or more articles (e.g., cans, containers). The defect tester may ensure that a user knows when the defect tester is functioning properly. In some embodiments, a single controller may control the defect tester and the machine arrangement.

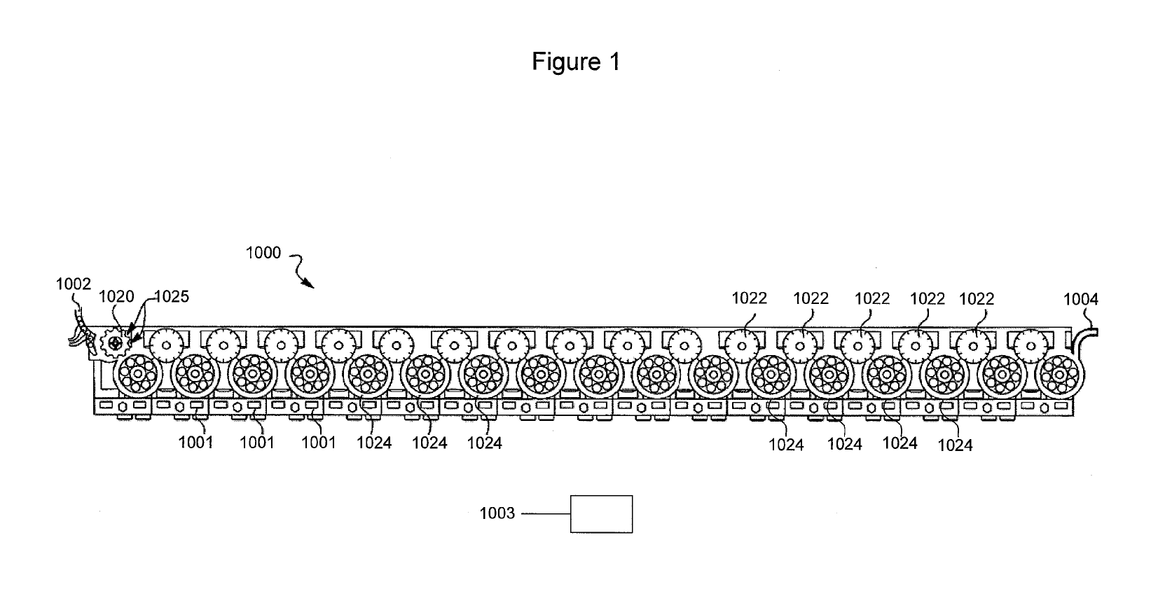

As shown in FIG. 1, a machine arrangement 1000 may comprise a plurality of machine modules 1001 arranged to cooperate with one another. At least one of the machine modules 1001, and in some embodiments, all of the modules, may comprise a turret arrangement (e.g., turret mechanism, turret assembly) configured to modify one or more articles (e.g., can, container) by performing a working operation (e.g., form, process) at a tooling end of the turret arrangement, on the article(s) as the article(s) passes from an article infeed 1002 to fill pockets in a starwheel 1020, 1022, 1024 (e.g., infeed starwheel 1020, turret starwheel 1022, transfer starwheel 1024), through the machine arrangement 1000, and then to an article discharge 1004. In some embodiments, the turret assembly may be a vertically or horizontally oriented turret assembly. The machine arrangement may be a recirculated machine line, a linear line (e.g., as in FIG. 1), or any other type of machine line.

After entering the machine arrangement 1000 through the article infeed 1002, each article may enter a pocket 1025 of a turret starwheel 1022 and then travel from the turret starwheel 1022 to a transfer starwheel 1024 and from the transfer starwheel 1024 to another turret starwheel 1022 until each article reaches the article discharge 1004.

Each starwheel 1020, 1022, 1024 may have any number of pockets 1025 to hold articles for processing or transfer. The transfer starwheel 1024 may have the same number of pockets as the turret starwheel 1022. Alternatively, the transfer starwheel 1024 may have more pockets then the turret starwheel 1022. For example, a turret starwheel 1022 may have six, eight, ten, twelve, or more pockets (e.g., stations) to hold six, eight, ten, twelve, or more articles, respectively, and a transfer starwheel 1024 may have twenty pockets, or any other suitable number. It will be recognized that a starwheel 1020, 1022, 1024 is capable of having one station up to any suitable number of stations.

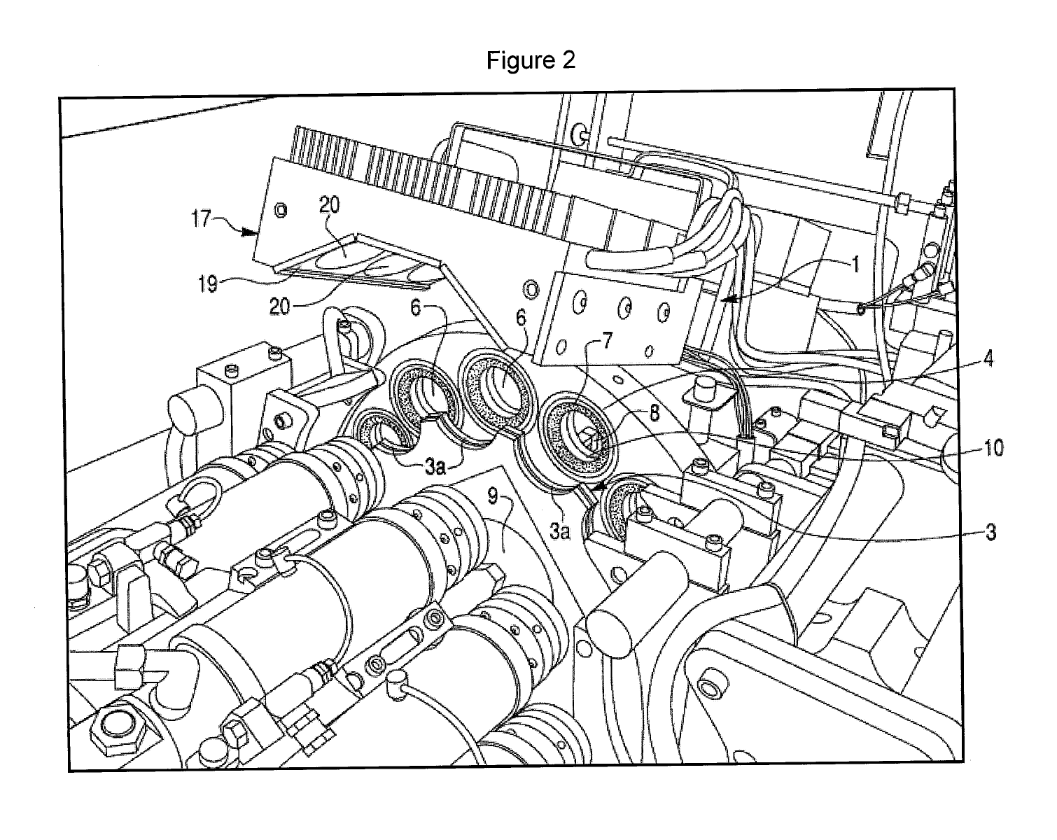

While passing through the machine arrangement 1000, an article(s) may enter a defect tester 1 (FIG. 2) (e.g., defect testing module) that detects defect(s) in the article(s). The defect tester 1 may be positioned anywhere along the length of the machine arrangement 1000. In some embodiments, the defect tester 1 may be the last module that an article(s) passes through before entering the article discharge 1004.

The defect tester 1 may include an article movement mechanism 2, a starwheel 3, a first disk 4 and, optionally, a second disk 10 (FIG. 2). The defect tester 1 may detect defects (e.g., one or more unintended openings) in article(s) that pass through the machine arrangement 1000. When a defect is detected, the defective article(s) may be removed from the machine arrangement 1000 manually or automatically.

The article movement mechanism 2 pushes the article(s) toward the first disk 4. The article movement mechanism 2 may be any suitable mechanism. For example, the article movement mechanism 2 may be a cam arrangement having one or more cam followers that follow a cam. The cam arrangement may assist in pushing the article(s) toward the first disk 4.

The starwheel 3 holds the article(s) and receives the article(s) from the transfer starwheel 1022. The starwheel 3 includes one or more pockets 3a (FIG. 2) configured to hold the article(s). Each pocket 3a may be configured to hold only one article. The pockets 3a may be any suitable size as long as each pocket 3a can hold an article going through the machine arrangement 1000. Once an article(s) is held in the pocket 3a, the article movement mechanism 2 may push the article toward the first disk 4 so that the defect tester 1 can determine whether the article contains a defect.

The starwheel 3 may have any number of pockets 3a to hold articles for processing. The starwheel 3 may have the same, more, or less pockets 3a than the infeed starwheel 1020, the turret starwheel 1022, and the transfer starwheel 1024.

The first disk 4 in the defect tester 1 may include one or more openings 6 (FIG. 2). For example, the number of openings 6 may equal the number of pockets 3a in the starwheel 3. Alternatively, the first disk 4 may have more or less openings than the number of pockets 3a in the starwheel 3. In some embodiments, the number of openings 6 may equal the number of pockets 3a.

The openings 6 in the first disk 4 may be any suitable size and shape. The openings 6 may be the same, a larger, or a smaller size than an article to be tested. One opening 6 may have a different or the same width as another opening 6. In some embodiments, each opening 6 may be the same size as the other openings 6 and a smaller size than the width of each article. In some embodiments, the openings 6 may be circular, substantially circular, rectangular or substantially rectangular shaped. Other shapes of the openings 6 are also contemplated. The openings 6 in the disk may all be the same, or one or more openings 6 may be a different shape than one or more other openings 6.

Each of the openings 6 may includes a covering 7 (FIG. 2) (i.e., first seal) that extends at least partially over the opening 6. The openings 6 are configured to align with the pocket(s) 3a in the starwheel 3 so that the covering 7 may form a seal between the top (e.g., open end) of the article and the first disk 4 such that the inside of the article is dark when an article is pushed toward and abuts the first disk 4. The covering 7 may be any suitable covering that is impermeable to radiation wavelengths. For example, the covering may be made of rubber, another suitable material, or combinations thereof.

The first disk 4 may be any suitable size (e.g., height and width) and shape. For example, the size of the first disk 4 may vary depending on the size of the machine arrangement. In some embodiments, the first disk 4 may be circular, rectangular, cylindrical, substantially circular, substantially rectangular or substantially circular. Alternatively, the first disk 4 may be another shape.

The first disk 4 and starwheel 3 may be mounted on the same shaft 9 (e.g., as shown in FIG. 2) or a different shaft (not shown). When the first disk 4 and the starwheel 3 are mounted on the same shaft 9, the first disk 4 and starwheel 3 rotate synchronously. When the first disk 4 and the starwheel 3 are mounted on a different shaft, the first disk 4 and starwheel 3 may or may not rotate synchronously.

The second disk 10 of the defect tester 1 may be stationary and is configured to act as a seal (FIG. 2) (i.e., second seal). The second disk 10 may cover and abut the first disk 4 such that the first and second disks 4, 10 are impermeable to radiation wavelengths.

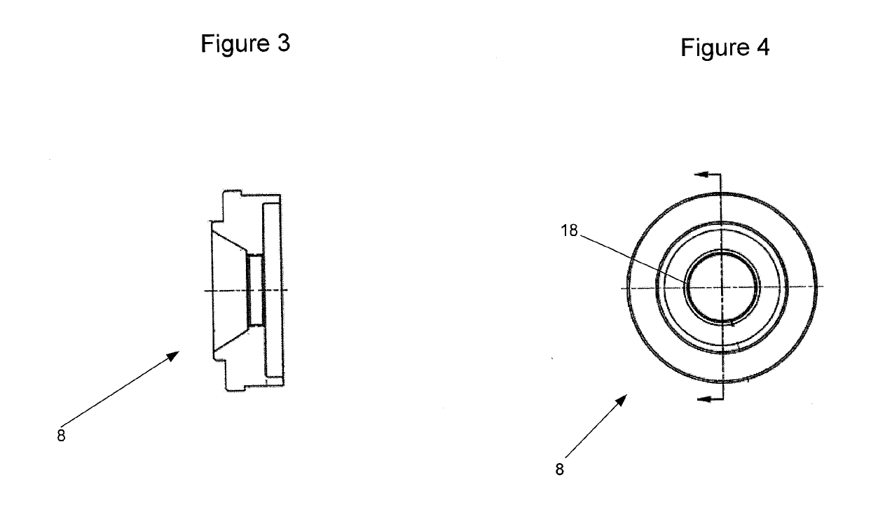

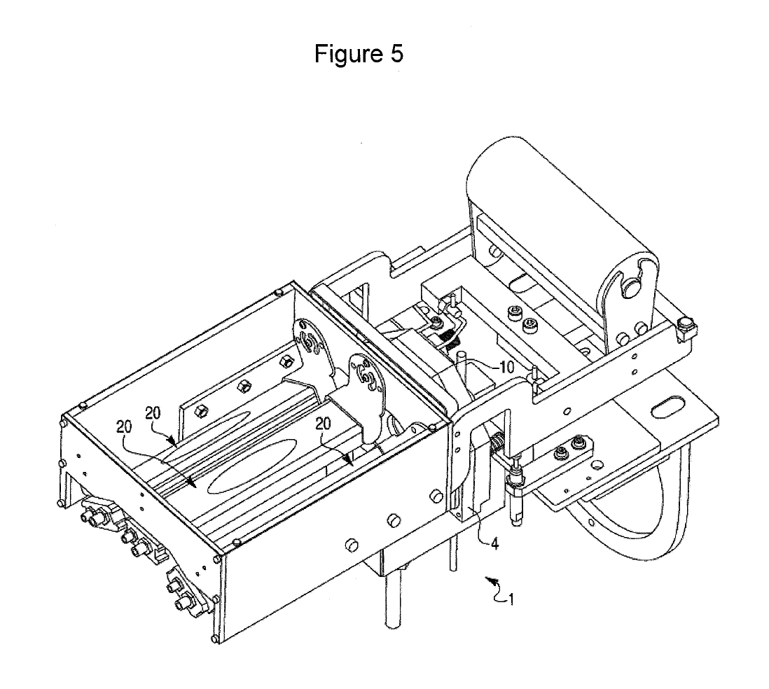

The second disk 10 may include or be coupled to one or more detector units 8 (FIGS. 2-4). The detector unit 8 communicates with a controller 1003 (FIG. 1) to determine whether the article includes a defect. When radiation wavelength(s) are directed on the exterior or outside of an article, the detector unit 8 determines whether radiation wavelength(s) enter the interior of the article. If the radiation wavelength(s) enter the article, the detector unit 8 communicates to the controller 1003 that there is a defect in the article. If the radiation wavelength(s) do not enter the article, the detector unit 8 may communicate to the controller 1003 that there is no defect in the article.

If the second disk 10 includes as many detector units 8 as pockets 3a in the starwheel 3, each detector unit 8 determines whether radiation wavelength(s) enter a separate article. If the second disk 10 includes less detector units 8 than pockets 3a, at least one of the detector units 8 may determine whether radiation wavelength(s) enter multiple articles.

The controller 1003 may be any suitable controller 1003. In some embodiments, the controller 1003 is the same controller 1003 that controls the rest of the machine arrangement 1000 to decrease the amount of controls that must be operated and/or monitored to determine whether radiation wavelength(s) enter an article and to control the machine arrangement 1000. The controller 1003 may be integrated into the controller of an existing machine arrangement 1000 or the controller 1003 may be integrated into a new machine arrangement 1000.

The detector unit 8 may include any suitable detecting mechanism 18 (e.g., as in FIG. 4) that can detect the presence of the wavelength that is directed on the outside of an article if the wavelength is within a certain range of wavelengths. In one non-limiting example, the detector unit 8 may include one or more radiation wavelength sensors that detect visible wavelengths in the blue/green spectrum. The detector unit 8 may be a conventional detecting mechanism 18, such as one constructed by SensL (Lexington, Mass.) or any other suitable detecting mechanism 18, so long as the detecting mechanism can detect the range of wavelengths directed on the article such that the presence of a defect may be detected.

When the second disk 10 abuts the first disk 4, each detector unit 8 may extend over at least one opening 6 in the first disk 4. As such, the detector unit(s) 8 can determine whether an article within a pocket 3a of the starwheel 3 contains a defect when radiation wavelength(s) are shown on the article. If the detector unit 8 extends over multiple openings 6, a single detector unit 8 can determine whether articles within pockets 3a contain defects.

The second disk 10 may or may not contain openings other than those that receive the detector unit 8 and/or are used to mount the second disk 10. The openings that receive the detector unit(s) 8 abut the detector unit(s) 8 so that radiation wavelength(s) cannot escape through the openings. If the second disk 10 contains openings other than those that receive the detector unit(s) 8, the openings, in embodiments, do not align with the openings 6 of the first disk 4 when the second disk 10 abuts the first disk 4 so that radiation wavelength(s) can enter the openings that do not align with the openings 6 of the first disk 4.

The second disk 10 may be any suitable size and shape. For example, the second disk 10 may be narrower or wider than the first disk 2. In embodiments, the second disk 10 is the same width or wider than the first disk 2. The second disk 10 may be circular, rectangular, cylindrical, substantially circular, substantially rectangular, substantially cylindrical or any other suitable shape. The first and second disks 3, 10 may be the same or a different shape.

In use, the starwheel 3 presents the open end of an article to a stationary detector unit 8 on the other side of the disk 4. To do so, the cam of the article movement mechanism 2 presses the article up against the covering 7 within the disk 4. Once an article is pushed toward and abuts the first disk 3 and covering 7, a wavelength emitter arrangement 17 (FIG. 2) may direct radiation wavelength(s) on the outside of the article. The wavelength emitter arrangement 17 may direct an intermittent (e.g. strobe) or continuous stream of radiation wavelength(s) on the article. The wavelength emitter arrangement 17 may direct radiation wavelengths around the article such that the radiation wavelength(s) may enter through any unintended opening (e.g. defect) in the article. The wavelength emitter arrangement may 17 direct radiation wavelengths around the article by surrounding the article or being positioned above the article and directing the radiation wavelengths on one or more reflectors 19 (FIG. 2) positioned around the article.

The wavelength emitter arrangement 17 may direct any suitable radiation wavelength(s) at the article. In some embodiments, the wavelength emitter arrangement 17 directs visible wavelength(s) at the article so that users can determine whether the wavelength emitter arrangement 17 is operating. In some non-limiting embodiments, the visible wavelength(s) may be in the blue/green spectrum. Alternatively, the visible wavelength(s) may be in other spectrums. The visible wavelength(s) is detected by the detector unit 8 if there is a defect in the article. In other words, the detector unit 8 is configured to detect wavelengths emitted within a visible wavelength range. In addition to the visible wavelength(s) directed by the wavelength emitter arrangement 17, the detector unit 8 may detect visible wavelength(s) not directed by the wavelength emitter arrangement 17. Regardless of whether the visible wavelength(s) directs from the wavelength emitter arrangement 17, a detection of any visible wavelength by the detector unit 8 indicates that there is a defect in the article. In some embodiments, using visible wavelength(s) has an advantage because users can detect whether the defect tester 1 is working with the naked eye when a visible wavelength is used. When an infrared wavelength is used, users cannot detect whether the defect tester 1 is working with the naked eye.

The wavelength range arrangement 17 may include one or more wavelength emitters 20 that direct radiation wavelength(s) on the article. The wavelength emitter arrangement 17 may be any suitable width, size and height. In some embodiments, one or more wavelength emitters may comprise a light emitting diode (LED). In some embodiments, the radiation wavelength(s) may be from any type of wavelength emitter source that is widely available.

In alternate embodiments, the defect tester 1 may include a first disk but not a second disk. When the defect tester 1 includes a first, but not second disk, the first disk may include the detector unit(s). Alternatively, the detector unit(s) may be included in something beside the first or second disk.

Advantages of defect tester embodiments may occur if the defect testers use visible wavelengths, since infrared wavelengths make it difficult for users to determine whether the defect tester is functioning properly. Advantages of defect tester embodiments may also occur because the defect testers use the same controller that the rest of the machine arrangement uses. Additional advantages of some defect tester embodiments occur because special wavelength emitters do not need to be used to direct radiation wavelength(s) on the article.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges or value provided. Accordingly, these terms should be interpreted as indicating that insubstantial or inconsequential modifications or alterations of the subject matter described and are considered to be within the scope of the disclosure, such that the recited numerical range or value may be close to or exactly within the range or value.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure. It is recognized that features of the disclosed embodiments can be incorporated into other disclosed embodiments.

It is important to note that the constructions and arrangements of the defect tester or components thereof as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

While the invention is susceptible to various modifications and alternative forms, specific embodiments have been shown by way of example in the examples and described in detail herein. It should be understood, however, that the invention is not intended to be limited to the particular forms disclosed. Rather, the invention is to cover all modifications, equivalents, and alternatives falling within the spirit and scope of the invention as defined by the appended claims.

What is claimed is:

1. A defect tester for detecting a defect in an article in a machine arrangement, the defect tester comprising:
a starwheel having one or more pockets configured to hold respective one or more articles;
one or more disks, each of the one or more disks having one or more openings, each of the one or more openings including a covering configured to form a seal with an open end of the article; and
one or more detector units configured to detect a range of radiation wavelengths in an interior of the article, the radiation wavelengths being directed on an exterior of the article, the one or more detector units being further configured to communicate to a controller whether a defect has been detected.

2. The defect tester of claim 1, wherein the controller controls the defect tester and the machine arrangement.

3. The defect tester of claim 1, wherein the article is a can or a container.

4. The defect tester of claim 1, wherein the one or more disks is one disk, the disk including the one or more detector units.

5. The defect tester of claim 1, wherein the one or more disks includes a first disk and a second disk, the second disk being configured to cover the first disk such that the first and second disks are impermeable to radiation wavelengths.

6. The defect tester of claim 5, wherein the second disk includes the one or more detector units, the one or more detector units extending over the one or more openings of the first disk.

7. The defect tester of claim 1, wherein the one or more detector units are configured to detect that an article within the one or more pockets of the starwheel includes a defect when radiation wavelengths are detected.

8. The defect tester of claim 1, wherein the amount of the one or more detector units corresponds with the amount of pockets of the starwheel.

9. The defect tester of claim 1, further comprising an article movement mechanism adapted to push the article toward the opening of the one or more disk, the article movement mechanism including one or more cam followers that follow a cam.

10. The defect tester of claim 1, wherein the covering is configured to extend over an open end of the article to seal an interior of the article, the article being positioned within the one or more disks.

11. The defect tester of claim 1, wherein the covering is impermeable to radiation wavelengths.

12. The defect tester of claim 1, wherein the one or more detector units include one or more radiation wavelength sensors configured to detect visible wavelengths.

13. A method of detecting one or more defects in one or more articles passing through a machine arrangement, the method comprising:
transferring an article from a component of the machine arrangement to a defect tester starwheel;
passing the article from the defect tester starwheel to an opening of one or more disks of a defect tester, the opening including a covering configured to form a seal with an open end of the article;
directing one or more radiation wavelengths on an exterior of the article;
detecting, using one or more detector units, the one or more radiation wavelengths in an interior of the article; and
communicating to a controller whether a defect has been detected.

14. The method of claim 13, further comprising passing the article to an article discharge immediately after exiting the defect tester.

15. The method of claim 13, further comprising, in response to detecting a defect, removing the article from the machine arrangement.

16. The method of claim 13, wherein the one or more articles is a can or a container.

17. The method of claim 13, wherein the one or more radiation wavelengths include visible wavelengths.

18. A machine arrangement for processing one or more articles, the machine arrangement comprising:
a plurality of modules arranged to cooperate with one another, at least one of the modules including a turret arrangement configured to modify one or more articles, the turret arrangement including at least one turret starwheel and at least one transfer starwheel, each of the at least one turret starwheel and the at least one transfer starwheel including a plurality of pockets adapted to hold or transfer the one or more articles;
a wavelength emitter arrangement for directing radiation wavelengths on the exterior of one or more articles;
a defect tester including one or more disks, each of the one or more disks having one or more openings, each of the one or more openings including a covering configured to form a seal with an open end of the one or more articles, the defect tester further including one or more detector units configured to detect the radiation wavelengths emitted by the wavelength emitter in an interior of the one or more articles; and
at least one controller for controlling at least one of the defect tester and the plurality of modules.

19. The machine arrangement of claim 18, wherein the radiation wavelengths include visible wavelengths.

20. The machine arrangement of claim 18, wherein the one or more disks includes a first disk and a second disk, the second disk being configured to cover the first disk such that the first and second disks are impermeable to radiation wavelengths.
